(19) United States
(12) Patent Application Publication
(10) Pub. No.: US 2014/0330676 A1
(43) Pub. Date: Nov. 6, 2014

(54) System And Method For Preserving Land Through An Independent Trust Organization

(71) Applicant: YOUR EARTH SHARE B.V., LD Amstelveen (NL)

(72) Inventors: Francisco Javier Vilaplana Oliva, Villajoyosa (ES); Jose Luis Garcia Cortell, Montevideo (UY); Jose Luis Garcia Munoz, Cocentaina Alicante (ES); David Mullor Ibanez, Alicante (ES); Anders Gustavo Hallmen Valleriestra, Pavoda (IT)

(73) Assignee: YOUR EARTH SHARE B.V., LD Amstelveen (NL)

(21) Appl. No.: 14/359,031

(22) PCT Filed: Nov. 16, 2012
(86) PCT No.: PCT/IB2012/002376

§ 371 Date: May 16, 2014

Related U.S. Application Data
(60) Provisional application No. 61/561,053, filed on Nov. 17, 2011.

(51) Int. Cl. G06Q 30/06; G06Q 50/16

(52) U.S. Cl. CPC G06Q 30/0619; G06Q 40/06; G06Q 50/16
USPC 705/26.44

(57) ABSTRACT

The present invention discloses a method for preserving any natural land through an independent trust organization. The organization must buy natural land in a plurality of countries all around the world land through a company. The trust organization shall then divides the land in smaller tiles and sells to clients the right to use the land without transferring the actual property title. The clients then become the beneficiaries of the trust organization. The organization keeps control over the ownership of the parcel of land in order to avoid inappropriate or undesired uses of the land, such as cutting the trees, harvesting the land or any type of human exploitation. The method shall be realized by a web-based system allowing the clients to buy titles from the owned land through a web-browser. The client, or user of the system, may envision the parcel of land through online maps and may buy merchandize related to the owned tiles of land.

### CROSS-REFERENCE TO RELATED APPLICATIONS

There are no cross-related applications.

### FIELD OF THE INVENTION

The present invention generally relates to fields of land preservation, and more specifically, to the field of methods for preserving land through a trust organization.

### BACKGROUND OF THE INVENTION

As the years go by and with the advancement of automotive technologies, more land is occupied and/or transformed by humans. As a consequence, such occupied area is enlarging as humans have to go farther in order to own a piece of land. As a result, many species are being annihilated or are pushed to edge of extinction, large forest that be transforming the carbonated gas into oxygen are cut and many waterways are polluted or are recessing.

In order to minimize such rate of occupancy, many strategies have been adopted or used through the years in order to preserve the land. For example, during the last century, many areas have been protected by government agencies and have been designated as national parks, national forests, reserves or controlled exploitation areas. The level of protection differs from one country to another. In many countries, governments try to take account of as many requests from the population. However, the governments having a limited budget devoted to land conservation, a marginal percentage, around 13 percent, of the surface of the Earth is considered as a protected area. Following a definition from the International Union for Conservation of Nature, a protected area is defined as “A clearly defined geographical space, recognized, dedicated and managed, through legal or other effective means, to achieve the long-term conservation of nature with associated ecosystem services and cultural values”.

Even if these measures are effective at protecting land, it would be desirable to use other methods to increase the protected area surface of the Earth in order to preserve the eco-systems, the floral and animal diversity and the heritage from our ancestors. To achieve such goals, methods have been used or invented to privately protect larger areas by selling parcel of land to private parties, such as individual and companies.

A method of promoting conservation easements in real property is disclosed in the U.S. patent application Ser. No. 10/633,403. The patent application discloses a method for identifying and securing a conservation easement owned by a first party. The identified parcel must be sold to an intermediate party which shall receive a maximum tax deduction benefit in exchange of the conservation easement. Such method allows the protection of land but uses, as incentive, the tax deduction benefits.

Another U.S. patent application identified by the application Ser. No. 11/858,482 discloses a method of preserving rainforest. The method discloses a first step where a land-trust company acquires a large parcel of land which is divided into small sections or tiles, wherein the sections or tiles are offered for sale through a website. The land-trust company may then uses the revenues from the sales to buy more land and increase the area of protection. The new owner of the land may then offers the land for sale or for rent on the website and realizes a profit from the investment. However, this method requires and, so far, is built on a method based only on transferring the land ownership to the tile buyer. Such transfer may potentially allow the tile owner to abuse of its ownership right and to incorrectly use the land, such as cutting the trees, harvesting the land or performing any type of human exploitation. Additionally, in order to transfer the ownership of a tile, the land-trust company must divide the larger parcel of land through legal means, which may incurs high costs and long delays during the process of preservation of the land. Also, in many occasions, a foreigner may not be allowed to directly own rainforest land in some countries or to divide original large rainforest land into small parcels of land. Indeed, the law of a plurality of countries requires a minimum area for a divided parcel. As a consequence, it is practically impossible to implement this method around the world in real life. Also, the buyer of the land tile may start speculating with the value of the tile as it is possible to resell it for a value higher than the price paid.

There is a need, therefore, for a method by which an independent trust organization manages the ownership titles of parcel of any type of natural land, being not restricted to rainforest land. Such organization should protect the land, by “only” selling to the buyer the usage rights to sections or tiles of the preserved land. The new method shall not be based on fiscal incentive or on potential value increase of the protected land. To summarize, the new method should not be based on speculation but on the simple but unique aim to preserve the land as it is.

### SUMMARY OF THE INVENTION

One of the objects of the present invention is to provide an independent trust organization, such as a trust, and a method to protect areas of land through beneficiaries. Another object of the invention is to avoid the legal or official transfer of ownership of a land tile to at least one beneficiary in order to ease the buying process and to restrict the speculating aspect of the selling and buying process of land to be protected. A further object to the present invention is to provide a system to automate the selling and the buying process through a remote graphical interface such as a web-based application.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

The aforesaid and other objectives of the present invention are realized by generally providing a method and system for preserving land through an independent trust organization.

A method for preserving any type of natural land, not only rainforest land, through an independent trust organization in accordance with the present invention may comprise the steps to gain ownership on at least one land parcel through an owning company, to divide the land in at least two smaller sections, commonly referred to by the name of tile or “Land Unit”, to offer the at least two tiles resulting from the parcel of land division to be offered for sale through a graphical interface, to allow a client to buy beneficiary rights on the at least one selected land tile, to send a certificate confirming the entitlement to beneficiary rights on the at least one selected land tile, to allow a beneficiary to buy merchandise associated with the purchased beneficiary rights and to reinvest the revenues from the selling process to protect additional areas of land areas.

In order to avoid the beneficiaries to speculate with the value of the tiles, the independent trust organization shall always retain the ownership rights of a legally constituted company, wherein the company owns all the tiles of a parcel of land. The legal constitution of the trust organization and each owning company must not allow the trust and company administrators to release, exploit, sell or modify in any way the parcel of land.

In the event where a decision related to a parcel of land or if, for any reason, the trust shall go bankrupt, the beneficiaries having beneficiary rights, such as owning options on the share of the owning company and being entitled to protect at least one tile of the parcel of land, shall be informed of the decision to be taken. The decision making process represents a rare event and may comprise, among others, the transfer of the ownership rights of the land owning company to the beneficiaries of the trust or even the selling of the parcel of land to obtain the current market price of this land and to distributed among the beneficiaries the revenues obtained from the sale.

The method preserving any type of natural land through an independent trust organization method is part of the recent concept of growing interest named “sustainable investment”. One of the objective of the method represents the protections of the largest area of natural land in the world. The investments realized by the beneficiaries or customer aims at increasing the chances of a “better future” for as many Earth citizens as possible without aiming only at a pure economical benefit. Another objective of the method relies on the appreciation of the future generations which will benefit from the transparency, the simplicity and the absence of speculation from the method.

The present invention comprises a system for realizing a method for preserving land through an independent trust organization, wherein the system comprises at least one server processing web requests from client devices, a plurality of client devices, such as desktop or laptop computers, at least one database server and at least one application server.

The at least one server processing web requests allows client devices to request a plurality of web pages from at least one dynamic web site. A wide area network, such as the Internet, allows the plurality of client devices to connect with the web server. The dynamic web site connects with an external map generator, such as Google Maps™ or MapQuest™ and displays to the user a geographic or satellite map of the at least one selected parcel of land.

The system further comprises an application server, wherein the application server provides an application layer for back office or back-end operations, such as committing a land tile purchasing transaction, completing the payment process through external payment services, such as PayPal™ or any other bank portal allowing payment services, managing the different aspects of the systems through land management and public communication management, saving or fetching the data to and from a data layer and or preparing and communicating a certificate for a beneficiary. A land management back-office module allows a user having administrator privileges to add, edit, suppress or inactivate any parcel of land record within at least one country.

To retain the data of the system, the system comprises a data layer. The data layer maintains a structure of data allowing the storage of information related to the parcel of land managed by the -independent trust organization, such as the coordinates of the land, a registry of the purchased tiles, the information related to the beneficiaries and users, the information on the certificates, the information required by the public communication module and the information related to the external payment services.

Within the scope of the present invention, a customer shall further be defined as a beneficiary, a user of the system or a client. The customer shall remain a beneficiary or owner of options on at least one share of the specific plot of land owning company. At any time, in order to avoid abuses in the exploitation of the land, the ownership rights shall be controlled by the trust established for that purpose.

At all time, the customer shall keep the right to sell, pass, give, bequeath and sponsor its beneficiary rights on the purchase land. However, such transfer of right shall be managed by the independent trust organization.

Within the scope of the present invention, a trust or trust organization shall further be defined as any independent trust organization, trust or any legal entity having an independent patrimony and being constitute for a cause or any special event. Typically, a trust holding the rights of property on at least one owning company shall be constituted and shall name the beneficiaries as the users of the protected land.

In accordance with the present invention, a beneficiary right shall be defined as a direct or indirect option on the ownership of the parcel of land. The option may refer to a stock option of the owning company through the trust organization.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a workflow diagram presenting the steps to a method for preserving land through an independent trust organization.

FIG. 2 is workflow diagram presenting the steps of a method to display, select and buy a land tile.

FIG. 3 is a graphical representation of a snaking division method for selling tiles having an isometric area.

FIG. 4 is a system diagram of the system to realize a method for preserving land through an independent trust organization.

### DETAILED DESCRIPTION OF THE PREFERRED EMBODIMENT

A novel system and method for preserving land through an independent trust independent organization will be described hereinafter. Although the invention is described in terms of specific illustrative embodiments, it is to be understood that the embodiments described herein are by way of example only and that the scope of the invention is not intended to be limited thereby.

The method for preserving land through an independent trust organization herein described allows an organization, such as a trust, to act as reserve of land parcels. The organization keeps ownership of the land parcels, uses any division method to create sections or tiles of the parcel and sells certificate entitling buyers to be beneficiaries of at least one selected section or tile of the parcel of land. The organization shall keep the control over the ownership of the parcel of land in order to avoid inappropriate or undesired uses of the land, such as cutting the trees, harvesting the land or any type of human exploitation.

Such method shall entitle any person to easily buy at least one land tile and to act as a beneficiary of the ownership title. The ownership title shall not be transferred to the client of the land in order to avoid complex legal processes such as ownership transfer act or mortgage acts. The tile beneficiary shall obtain the right to preserve the land as it is at the moment of the buying.

In a preferred embodiment, the trust shall reinvest 100% of the money received from the land tile buyers in order to purchase new land to protect. However, other embodiment of the principle of the present invention may allow the trust to reinvest a different percentage of the revenues from selling rights to the beneficiaries.

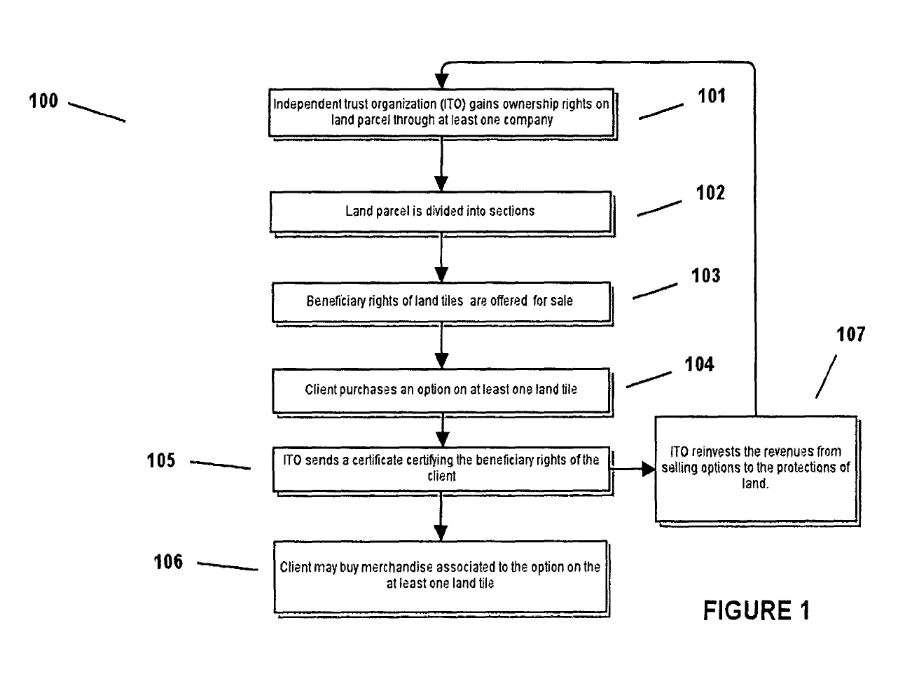

Now referring to FIG. 1, the method for preserving land through a trust 100 is presented. As a starting point, the method 100 comprises a step for a trust to gain control of the ownership on at least one land parcel through at least company 101. To gain ownership, the trust shall be legally constituted and shall be entitled to own movable or immovable objects, such as land parcel or company ownership, such as shares or options of a company, within an independent patrimony. A company, wherein the company is or may be constituted within the country or within any other country where a parcel of land is located, shall purchase at least one parcel of land. However, in another embodiment, the company may be constituted in another country and the company may operate as a partnership, a sponsorship entity, a business entity or any other legal method to carry a business. The owning company shall comprise a mechanism to issue at least one stock option, share, obligation or any other incentive program of the ownership of the company. The trust organization shall buy a percentage of the share of the owning company. In a preferred embodiment, the percentage shall be 100%. As a result, the trust owns the shares of a company that is the legal owner of at least one parcel of land. In a preferred embodiment, each parcel of land shall be owned by a single company. However, in another embodiment, an owning company may hold more than one parcel of land. As a result, the trust offers to sell the options on the share of the owning company to the clients through beneficiary rights.

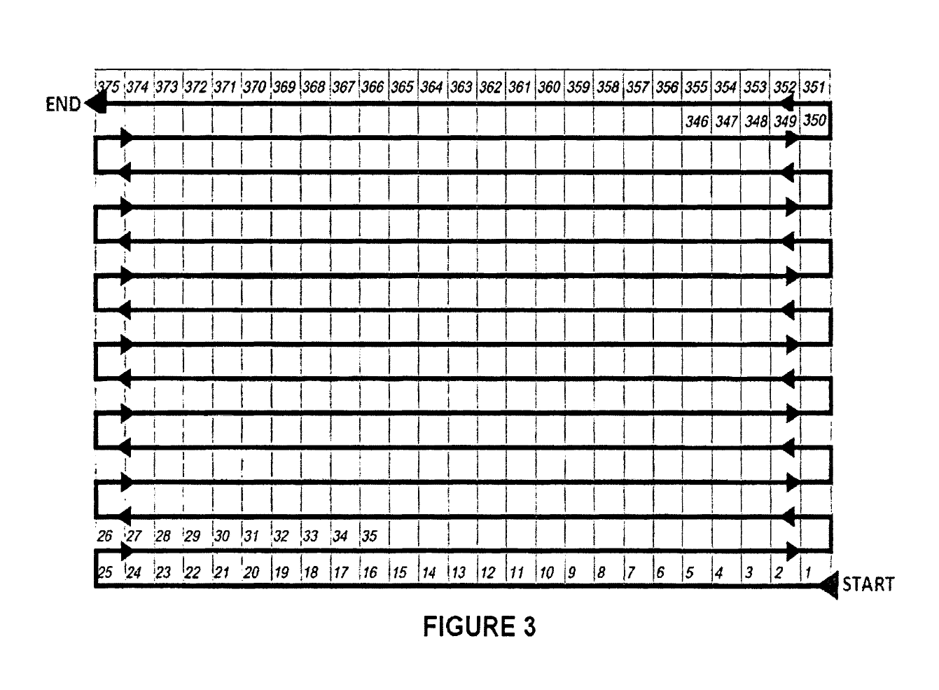

Once the organization possesses the ownership rights on the land parcel 101, it shall divide the land into at least two smaller sections 102, commonly referred to by the name of tile or “Land Unit”. Now referring to FIG. 3, the method known as “snaking” division process is presented. This method divides a parcel of land into geometrical forms, such as square or rectangle, having identical area, such as 1,000 square-meters, which shall be referred as “Plot”. Depending on the surface area ordered by a client, the division process uses one of the corners of the grid as a starting point, such as the lower right corner. Using the plot located at the starting point, the next plots shall be numbered following any direction, such as the west direction. At the end of the row, the next selected plot shall be located on the first free vertically aligned plot of the next upper row. Depending on the direction of the previous row, the first free vertically aligned plot shall be the first or the last plot of the row. From this plot, the following selected plots shall be located in the opposite direction of the previous row, such as the east direction. The same concept shall be repeated to the following rows until all plot have been assigned to the grid of the parcel of land.

The resulting division process may be similar to a snaking process. This bidirectional method allows to continuously sell tiles having different sizes without breaking the morphology of the parcel of land. Also, this method allows the organization to equally divide a parcel of land while minimizing the empty plots, independently of the parcel of land shape and terrain. However, it might be required, in some difficult or uneven terrains, to manually define one or more plots. In this event, the resulting plot may have a different shape from the other plots of the parcel of land.

In another embodiment, the snaking method shall be replaced by any land division method allowing the parcel of land to be divided in a plurality of plots having the same surface.

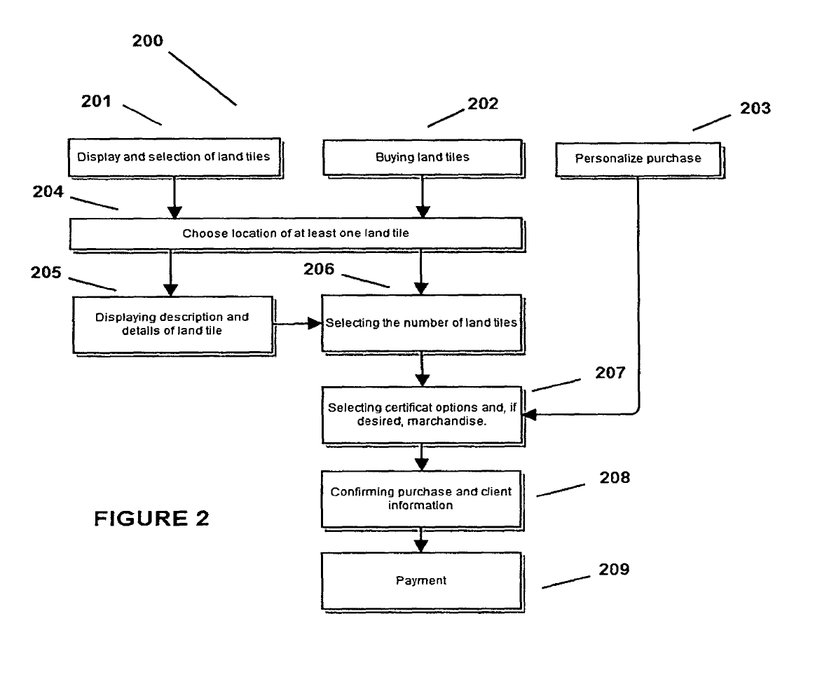

Now referring back to FIG. 1, the at least two tiles resulting from the parcel of land division shall be offered for sale through a graphical interface 103. In a preferred embodiment, any person willing to consult or buy a land tile through a web-based interface using a method to display, select and/or buy a land tile 104 and 200, method that is detailed at FIG. 2. The method 200 comprises at least three entry points, the displaying and selection of land tiles offered for sale to an unregistered user 201, the buying process for a registered user 202 and the personalization of a previous purchase by a beneficiary user 203.

Through the first two entries points to the system 201 and 202, a user shall select the location of at least one land tile 204. In a preferred embodiment, the user shall select the desired country where the land to be protected is located. On selection of the country, a list of the available parcel is presented. From this step, the user may either request the displaying of the description and details of a land parcel 205 or directly select the area or number of plots to purchase within the parcel of land 206. The step 205 displays an image of the selected parcel of land and the related information, such as a description of the parcel, the exact geographical location, the area of the parcel and the size options, such as the number of plots to buy. The user must input through the graphical interface the number of desired plots 206.

The method comprises a step allowing the user to select a personalized certificate or to buy personalized merchandize 207, such as a t-shirt, a mug or any item customized with the coordinated of the protected land or a satellite image representing the parcel of land. At this point, the user shall input the name of the titleholder to be printed on the certificate that confirms the beneficiary rights. The titleholder of the certificate may be the user, a friend of the user, a relative, a company or any other living person or active company. The user may also change the date to appear on the certificate. Typically, the date associated to the certificate shall be the date of the purchase. However, any future date may be associated to the certificate, such as birthday date, wedding anniversary, a special event or any desired date. The certificate may also contain a brief description of the land and the exact coordinates of the assigned land.

The step 207 may allow the display of a preview of the electronic certificate. In the preferred embodiment, the resulting certificate shall be communicated to the beneficiary through any electronic communication mean. However, in another embodiment, the digital certificate may be printed and sent at any postal address.

The step 207 may also allow the user to buy and personalize at least one merchandize item, wherein such merchandize item may be customized by selecting the colour, the size or a printed image to be printed on the selected item.

Following the display of the digital certificate 207, the user shall confirm the purchase 208 by accepting the sale conditions and by providing any required client information, such as the client name, the shipping address, the billing address and any other required client information.

The method 200 is completed by the purchasing process step 209. The user shall input the information related to the payment method, such as a credit card number, a payment intermediary, such as PayPal™ or any other method of payment. On confirmation of the payment information, a summary of the at least one selected land tile and at least one personalized certificate and merchandize item may be displayed to the user through a graphical user interface. The user shall submit the information. In the event where the payment is confirmed, a confirmation notification is communicated through any electronic communication method, such as email, SMS, instant message or any other standardized method, the notification comprising at one certificate indicating detailed information regarding the piece of land.

In the preferred embodiment, the amount of money paid during the purchasing process comprises the maintenance fees related to the at least one tile purchased by the client during a period of time, such as ten years. The maintenance fees do not comprise the unexpected taxes or costs that may occurred during the prepaid period of time. After the prepaid period of time has elapsed, the client may choose to pay the expenses for a recurring period of time, such as one year or two years or to relinquish the land that will remain free to be allocated to a new client.

Still referring to FIG. 2, a third entry point allows a registered user having beneficiary rights to at least one existing land tile to obtain a new certificate or to purchase at least one merchandize item 203. The step to personalize a purchase 203 may comprise a step to be authenticated (not shown), a step to select at least one certificate option and at least one personalized merchandize item 207, a step to confirm the purchase 208 and a step to pay for the purchased elements 209.

Now referring back to FIG. 1, once the client has bought a beneficiary right on the at least one selected land tile 104, the trust organization uses an electronic communication method to send a certificate confirming the entitlement to beneficiary rights on the selected land tile 105. In the preferred embodiment, the communication method used is email. However, in another embodiment, the certificate may be sent through any other electronic communication mean, such as retrieving the certificate through a web-based interface or sending the certificate via an SMS message. In a further embodiment, the certificate may be printed and mailed to the beneficiary.

The beneficiary may, at any time, buy at least one merchandise item associated with the at least one purchased beneficiary right 106. The at least one merchandize item, such as a t-shirt, a mug, a towel or any other merchandizing item, may be identified with the coordinates of the protected land area.

Lastly, the independent trust organization must reinvest a specific percentage of the revenues received from the selling of beneficiary rights in the protection of land 107. In a preferred embodiment, the percentage is fixed based only on the total administrative fees incurred by the trust organization. The fees must be kept as low as possible in order to allow the largest area of land to be bought. The act of protection of land must only include the buying of new parcel of land to protect through a legally constituted company 101.

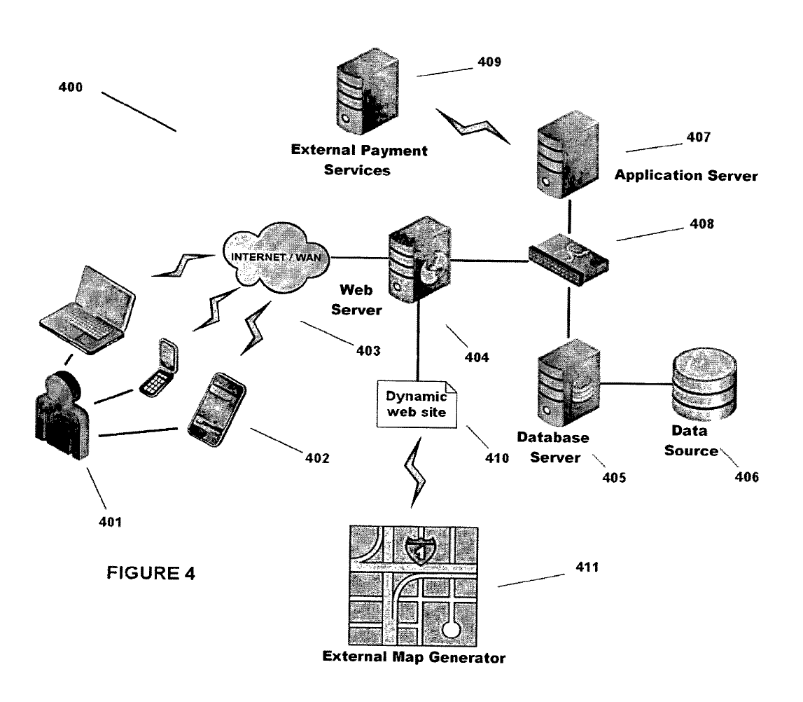

Now referring to FIG. 4, a system for realizing a method for preserving land through a trust organization 400 is presented. The system 400 may comprise at least one server processing web requests from at least one client device (also referred as “web server”) 404, a plurality of client devices 402, such as desktop or laptop computers, at least one database server 405, at least one application server 407.

The at least one web server 404 allows client devices 404 to request a plurality of web pages from the dynamic web site 410. A wide area network, such as the Internet, allows the plurality of client devices 404 to connect to the web server 404 using standard network protocol such as TCP/IP. The web server holds the interface layer and processes requests of the at least one client device 402 in order to provide a web-based graphical interface to a plurality of users 401. The web server 404 hosts at least one dynamic web site 410 allowing a user or the existing beneficiaries to dynamically navigate through the different steps of buying at least one land tile. The dynamic web site may connect with an external map generator, such as Google Maps™ or MapQuest™ in order to display to the user 401 a geographic or satellite map of the at least one selected parcel of land.

The system 400 comprises an application server 407, wherein the application server 407 provides an application layer for at least one back office or back-end operation, such as committing a land tile purchasing transaction, completing the payment process through external payment services 409, such as PayPal™ or any other bank portal, managing the different aspects of the systems through land management 412 and public communication management 413, saving or fetching the data to and from a data layer 405 and 406 or preparing and communicating a certificate for a beneficiary. The application server 407 processes the plurality of requests from the dynamic web site 410 hosted by the web server 404. The requests may be communicated through any remote method call procedure such as web services, object invocation services or any standard remote call protocol. Such requests may comprise the retrieval of any parcel of land related information, the number of remaining tiles in any specific parcel of land or the available colours for at least one merchandize object.

The land management back-office module 412 allows a user having administrator privileges to add, edit, suppress or inactivate any parcel of land record within at least one country.

The public communication module 413 allows a user having administrator's privileges to communicate with the beneficiaries through an electronic communication method such as email, Facebook™ message, SMS or any other standardized electronic communication method.

To persist the data of the system, the system 400 comprises a data layer, wherein such data layer may comprise at least one database server 405, such as relational database server and/or at least one data source 406, such as a text-based file, a binary file or an XML file. The data layer maintains a structure of data allowing the storage of information related to the parcel of land managed by the independent trust organization, such as the coordinates of the land, a registry of the purchased tiles, the information related to the beneficiaries and users, the information on the certificates, the information required by the public communication module 413 and the information related to the external payment services 409.

The three layers, interface layer, 404, 410 and 411, data layer 405 and 406 and the application layer 407, 412, 413 and 409 may be physically installed on a plurality of physical servers. If used with a plurality of servers configuration, the different layers communicate with each other through a computer network 408 using standard computer network protocol, such as TCP/IP and application communication protocol such as web services through SOAP. However, the layers may be physically installed on a single physical server to keep the complexity of the system low.

While illustrative and presently preferred embodiments of the invention have been described in detail herein-above, it is to be understood that the inventive concepts may be otherwise variously embodied and employed and that the appended claims are intended to be construed to include such variations except insofar as limited by the prior art.

What is claimed is:

1) A method for preserving land through an independent trust organization, the method comprising:
a. the independent trust organization to gain control of the ownership on at least one land parcel through at least one business entity;
b. dividing the land into at least two smaller tiles;
c. offering for sale through a graphical interface the at least two tiles resulting from the parcel of land;
d. allowing a client to buy a beneficiary right on at least one selected land tile;
e. sending through a communication method to the client a certificate, wherein the certificate confirms the entitlement to beneficiary rights on the selected land tile;
f. the independent trust organization reinvesting a specific percentage of the revenues received from the selling of beneficiary rights.

2) A method for preserving land according to claim 1, wherein the independent trust organization manages the transfer of beneficiary right and wherein the beneficiary right of a client comprises the right to sell, pass, give, bequeath and sponsor the beneficiary rights on the purchased tiles.

3) A method for preserving land according to claim 1, wherein the amount of money paid during the buying step comprises the maintenance fees related to the at least one tile bought by the client for a determined period of time.

4) A method for preserving land according to claim 3, wherein the period of time is ten years.

5) A method for preserving land according to claim 1, wherein the method further comprise the step for a client to buy at least one merchandise item associated with the at least one purchased beneficiary.

6) A method for preserving land according to claim 1, wherein the specific percentage of the revenues reinvested is 100%, except for the administrative fees incurred by the trust organization.

7) A method for preserving land according to claim 1, wherein the communication method is an email.

8) A method for preserving land according to claim 1, wherein the division process of the land uses the snaking method, wherein the snaking method comprises:
a. the parcel of land is divided as a grid of tiles;
b. the division process uses one of the corners of the grid as a starting point
c. using the tile located at the starting point, the next tile shall be numbered following any horizontal direction;
d. at the end of the row, the next selected tile shall be located on the first free vertically aligned tile of the next upper row;
e. based on the direction of the previous row, the first free vertically aligned tile shall be the first or the last tile of the row;
f. from this tile, the following selected tiles shall be located in the opposite direction of the previous row;
g. the method shall be repeated on the following rows until all tiles have been assigned to the grid of the parcel of land.

9) A method for preserving land according to claim 1, wherein the at least one business entity is a legally constituted company;

10) A method for preserving land according to claim 1, wherein the step for a client to buy a beneficiary right on at least one selected land tile comprises:
a. displaying and selecting the land tiles offered for sale;
b. buying at least one tile as a registered user;
c. personalizing of a previous purchase as a beneficiary user.

11) A method for preserving land according to claim 10, wherein displaying and selecting the land tiles offered for sale comprises:
a. selecting the location of at least one land tile;
b. requesting the display of the description and details of a land parcel;
c. selecting the area or number of tiles to purchase within the parcel of land;
d. selecting a personalized certificate;
e. buying personalized merchandize;
f. confirming the purchase by accepting the sale conditions and by providing any required client information;
g. completing the payment of the selected tiles.

12) A method for preserving land according to claim 10, wherein the method to display and select the land tiles further comprise the step to buy personalized merchandize.

13) A method for preserving land according to claim 10, wherein buying at least one tile as a registered user comprises:
a. selecting the location of at least one land tile;
b. selecting the area or number of tiles to purchase within the parcel of land;
c. selecting a personalized certificate;
d. buying personalized merchandize;
e. confirming the purchase by accepting the sale conditions and by providing any required client information;
f. completing the payment of the selected tiles.

14) A method for preserving land according to claim 13, wherein the method to display and select the land tiles further comprise the step to buy personalized merchandize.

15) A method for preserving land according to claim 10, wherein personalizing of a previous purchase as a beneficiary user comprises:
a. selecting a personalized certificate;
b. buying personalized merchandize;
c. confirming the purchase by accepting the sale conditions and by providing any required client information;
d. completing the payment of the selected tiles.

16) A method for preserving land according to claim 15, wherein the method to display and select the land tiles further comprise the step to buy personalized merchandize.

17) A system for realizing a method for preserving land through a trust organization, the system comprising:
a. at least one web server processing web requests from at least one client device
i. configured for client devices to request a plurality of web pages from the dynamic web site;
b. a plurality of client devices configured to connect to the web server;
c. at least one database server configured to maintain a structure of data allowing the storage of information related to the parcel of land management;
d. at least one application server:
i. configured to provide at least one back office operation;
ii. configured to provide a public communication module;
wherein the at least one web server, the at least one data storage service, the at least one application server and the at least one client device are connectable through a communication network.

18) A system for realizing a method for preserving land according to claim 17, wherein the dynamic web site displays to the user a geographic or satellite map of the at least one selected parcel of land.

19) A system for realizing a method for preserving land according to claim 17, wherein the application server is configured:
a. To complete the payment process through external payment services;
b. to manage the different aspects of the systems through land management;
c. to save or fetch the data to and from a data layer;
d. to prepare and communicate a certificate for a beneficiary.

20) A system for realizing a method for preserving land according to claim 17, wherein the application server, the web server and the database server are configured on the same physical computer.
